(19) United States
(12) Patent Application Publication
(10) Pub. No.: US 2003/0021660 A1
(43) Pub. Date: Jan. 30, 2003

(54) Land, air, sea flatrack and roller assembly

(76) Inventor: James Sterling Wells, Fountain Valley, CA (US)

Correspondence Address: HARNESS, DICKEY & PIERCE, P.L.C., P.O. BOX 828, BLOOMFIELD HILLS, MI, 48303, US

(21) Appl. No.: 09/912,902

(22) Filed: Jul. 25, 2001

(51) Int. Cl. B65F 9/00

(52) U.S. Cl. 414/340

(57) ABSTRACT

A flatrack for supporting and transporting cargo on a cargo aircraft (air), within an ISO container (sea), and on a PLS truck system (land) without the need of a crane or K-loader is provided. The flatrack includes a main body portion and a pair of longitudinally extending planar surfaces extending along an underside of the main body portion. The pair of longitudinally extending planar surfaces are sufficiently spaced apart so as to roll along a plurality of rollers positioned within the cargo aircraft. The pair of longitudinally extending planar surfaces further includes a retaining flange engageable with a pair of retaining rails also positioned within the cargo aircraft to permit air transport. A plurality of cargo restraint connectors are coupled to the main body portion of the flatrack so as to permit connection with a standard cargo securing system within an ISO container to permit sea transport. A PLS rail mounting system is also provided that extends along the underside of the main body portion. The PLS rail mounting system is sized to engage the PLS retaining system of the PLS truck system to permit land transport on a single flatrack. A teeter roller assembly is optionally provided on the end of the cargo door of the aircraft to permit combat offloads of the flatrack of the present invention.

### FIELD OF THE INVENTION

The present invention relates to interface pallets and, more particularly, to an interface pallet system capable of being transported within an International Standard (ISO) container, United States Army Palletized Loading System (PLS), or British Drop Cargo System, which does not require the use of material handling equipment.

### BACKGROUND OF THE INVENTION

Modern military transport aircraft, such as the C-17, are used to transport flatracks, “Container Roll In/Out Platforms” (CROPs), and ISO container loads. However, these structures can not be loaded directly onto the loading ramp of a C-17 aircraft. Instead, three standard 463L pallets are required for supporting the CROP, flatrack, or ISO container thereon. The three standard 463L pallets must first be secured together in a “married” configuration. Next, a large crane is required to lift the CROP, flatrack, or ISO container onto the married pallet system. The load must then be secured to the pallet system with restraint straps or chains. Finally, material-handling equipment such as a K-loader must be used to transport the entire assembly and load it onto the loading ram of the aircraft and into the fuselage thereof. This procedure is necessary because the CROP, flatrack, or ISO container can not be rolled directly on the roller assemblies of the loading ramp of the aircraft because the complexly-shaped lower surface of these cargo supporting platforms or containers. That is, existing CROP, flatrack, or ISO containers have numerous support members along their underside that prevents rolling of such pallets along the aircraft cargo roller system. Thus, the use of the married pallet has heretofore been necessary.

The foregoing procedure thus requires a crane and a K-loader to be present at the site where the aircraft is to be loaded and also at the location where the aircraft is to be unloaded. This procedure also prevents what is termed a “combat offload,” where the cargo would be permitted to simply roll off the loading ramp of the aircraft while the aircraft is moving along a runway or parking ramp immediately after landing. Since combat offloads are therefore prohibited when employing a married pallet system, the delivery of a CROP, flatrack, or ISO container is limited to only those locations where a large crane and K-loader are available. This eliminates the possibility of off-loading cargo at generally small, austere airfields where such equipment is not available.

Often, material handling equipment such as a crane and a K-loader must be flown ahead of time on a separate aircraft to the location where the aircraft carrying the CROP, flatrack, or ISO container is to be offloaded. On occasion, as many as three flights may be needed to deliver one CROP, flatrack, or ISO container to an austere airfield (i.e., one flight to transport a K-loader, one flight to transport a crane, and one flight to transport the CROP, flatrack, or ISO container).

Accordingly, there exists a need in the relevant art to provide a pallet interface system that eliminates the need for a married pallet system to be used in the process of loading and supporting a CROP, flatrack, or ISO container being transported on a cargo aircraft. Furthermore, there exists a need in the relevant art to provide a single pallet interface system that can be positioned on the roller assembly of a loading ramp of a cargo aircraft, such as a C-17, that also is connectable with existing ISO fitting systems, PLS systems, and aircraft pallets systems such that the entire assembly can be loaded onto or unloaded from the aircraft without the need for a large crane, and which permits combat offloads to be performed. Still further, there exists a need in the relevant art to provide a pallet interface system that overcomes the disadvantages of the prior art.

### SUMMARY OF THE INVENTION

A flatrack for supporting and transporting cargo on a cargo aircraft (air), within an ISO container (sea), and on a PLS truck system (land) without the need of a crane or K-loader is provided. The flatrack includes a main body portion and a pair of longitudinally extending planar surfaces extending along an underside of the main body portion. The pair of longitudinally extending planar surfaces are sufficiently spaced apart so as to roll along a plurality of rollers positioned within the cargo aircraft. The pair of longitudinally extending planar surfaces further includes a retaining flange engageable with a pair of retaining rails also positioned within the cargo aircraft to permit air transport. A plurality of connectors are coupled to the main body portion of the flatrack so as to permit connection with a standard cargo securing system within an ISO container to permit sea transport. A PLS rail mounting system is also provided that extends along the underside of the main body portion. The PLS rail mounting system is sized to engage the PLS retaining system of the PLS truck system to permit land transport on a single flatrack. A teeter roller assembly is optionally provided on the end of the cargo door of the aircraft to permit combat offloads of the flatrack of the present invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an environmental view illustrating the loading/unloading of the flatrack of the present invention onto a cargo aircraft using an optional truck;

FIG. 2 is an end view illustrating two flatracks according to the present invention being mounted within the cargo aircraft;

FIG. 3 is an enlarge perspective view illustrating the support rails of the flatrack engaging the cargo rail system of the cargo aircraft according to the present invention;

FIG. 4 is an enlarge perspective view illustrating the support rails of the flatrack according to the present invention;

FIG. 5 is a partial plan view illustrating a possible positioning arrangement of the flatracks within a cargo aircraft according to the present invention; and

FIG. 6 is a side view illustrating a combat offload of the flatrack according to the present invention.

### DETAILED DESCRIPTION OF THE PREFERRED EMBODIMENTS

The following description of the preferred embodiment is merely exemplary in nature and is in no way intended to limit the invention, its application, or uses.

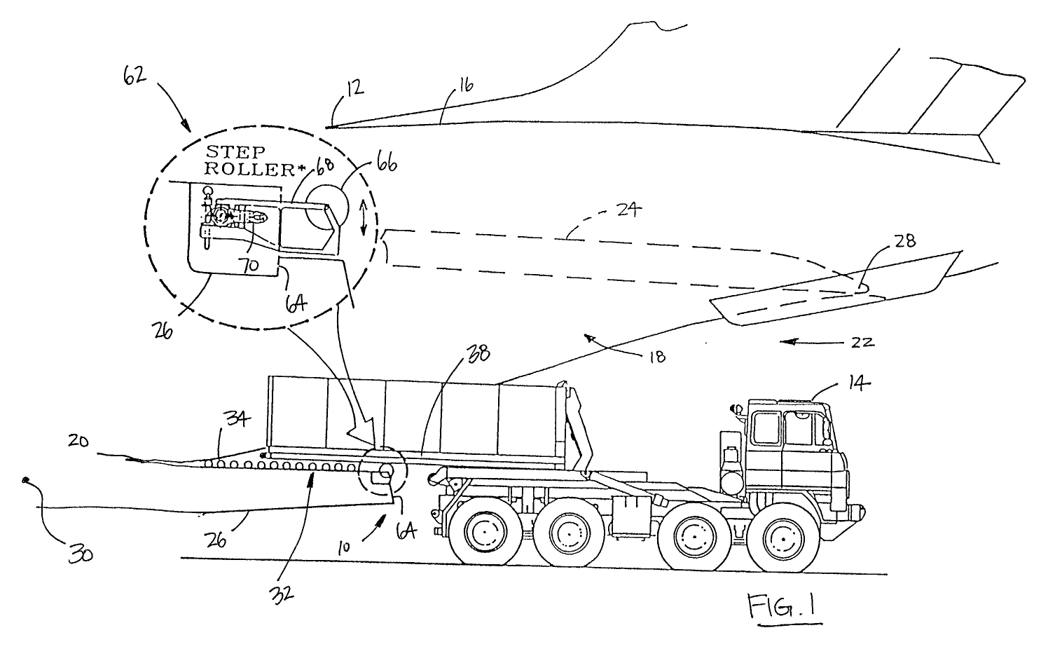

Referring to the figures, a flatrack 10 is illustrated according to the principles of the present invention. Specifically with reference to FIG. 1, flatrack 10 is illustrated for use in concert with an aircraft 12 and an optional loading vehicle 14. Aircraft 12 is preferably a cargo type aircraft, such as a Boeing C-17, having a fuselage 16 and a cargo compartment 18 located within fuselage 16. Cargo compartment 18 includes a deck 20 extending generally throughout cargo compartment 18 and an actuatable cargo ramp system 22. Cargo ramp system 22 is positionable in a fully closed position, a fully opened position, and various intermediate positions between the fully closed position and the fully opened position. In this particular embodiment, cargo ramp system 22 includes an upper cargo door 24 and a lower cargo door 26. In the fully closed position, upper cargo door 24 and lower cargo door 26 are sealed and locked against fuselage 16 of aircraft 12 to form a generally smooth aerodynamic surface. In the fully opened position, upper cargo door 24 pivots about an upper hinge member 28 into a generally horizontal position within fuselage 16. Lower cargo door 26 pivots about a lower hinge member 30 into a generally extended position. Aircraft 12 further includes a conventional cargo roller system 32 disposed within cargo compartment 18. Cargo roller system 32 includes a plurality of rollers 34 pivotally journalled to a track 36. Track 36 is typically coupled to deck 20 of aircraft 12 in a longitudinal direction to support cargo pallets thereon. Conventional cargo pallets typically are rolled over the plurality of rollers 34 and into position for transport. Locking members (not shown) are then used to secure the cargo pallets in position.

Flatrack 10 is designed to be compatible with cargo roller system 32 and the locking members typically used in cargo aircraft, such as but not limited to the C-5, C-17, C-130, and C-141. Additionally, flatrack 10 is designed to be compatible with standard ISO shipping containers commonly used for sea transport and standard demountable container systems commonly used with trucks and trailers. More particularly, flatrack 10 is further designed to be compatible with the cargo transportation system of the United States Army known as the Palletized Load System (PLS), which utilizes a pair of longitudinally-extending rail members disposed along the underside of the pallet. These longitudinally extending rail members are slidably received within a pair of corresponding rail members to retain the pallet aboard a transport truck.

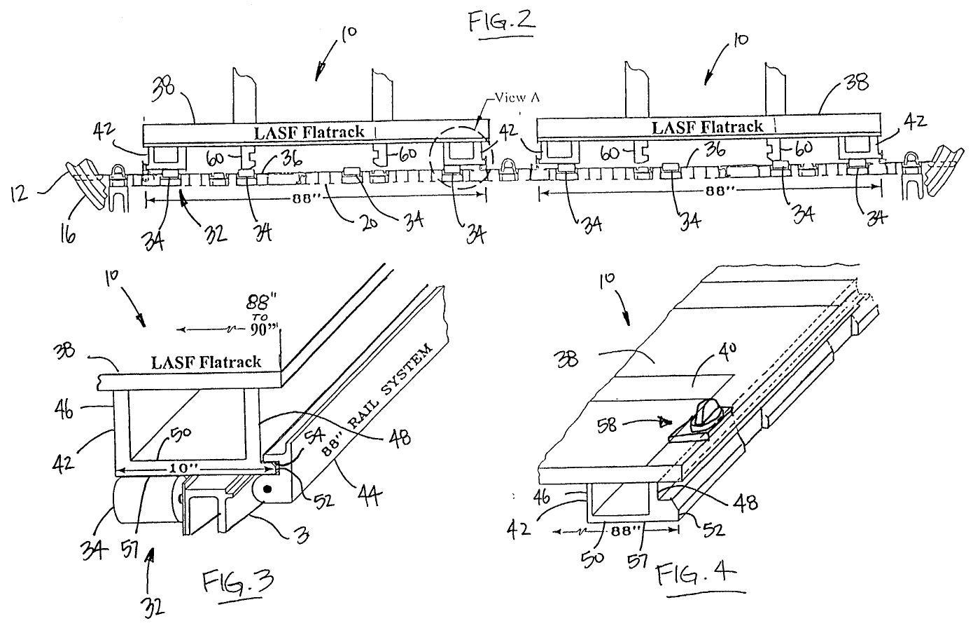

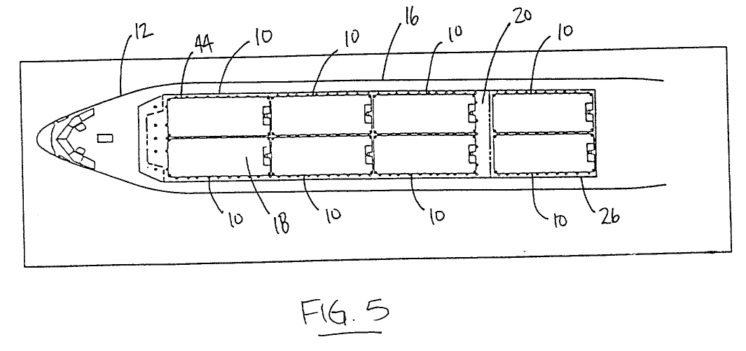

With particular reference to FIGS. 2-4, flatrack 10 generally includes an upper surface 38 defining a generally flat support surface for supporting cargo thereon. It should be appreciated that upper surface 38 may include a plurality of retaining or mounting features 40 formed thereon to aid in the transporting of cargo. By way of non-limiting example, the plurality of mounting features 40 may include depressions, protrusions, bores, hooks, stop members, and the like that engage the cargo to prevent slippage.

Flatrack 10 further includes a pair of longitudinally extending support rails 42 that are fixedly coupled to upper surface 38. The pair of support rails 42 is sufficiently sized to engage and be retained by a standard aircraft cargo rail system 44, which will be described in detail below. Each of the pair of support rails 42 includes an inboard member 46 downwardly extending from upper surface 38, an outboard member 48 downwardly extending from upper surface 38, and an interconnecting member 50 interconnecting the distal ends of inboard member 46 and outboard member 48. Interconnecting member 50 extends outboard past outboard member 48 to provide a retaining flange 52. Retaining flange 52 is adapted to engage within a receiving slot 54 formed in cargo rail system 44. Specifically, cargo rail system 44 generally includes a pair of rail member 56 each having inwardly turned receiving slots 54 extending therethrough. Cargo rail system 44 is of conventional design and is widely known as a 463L cargo rail system, which permits cargo pallets to be locked in place in cargo aircraft, such as the C-17 aircraft manufactured by The Boeing Company. Unlike many prior art pallets, interconnecting member 50 further includes a generally flat underside surface 57, which permits rolling of flatrack 10 on the plurality of rollers 34.

Flatrack 10 further includes a plurality of well known, male ISO locking assemblies 58 incorporated along flatrack 10 to permit flatrack 10 to be secured to complimentary ISO locking structure incorporated on a “Container Roll In/Out Platform” (CROP), flatrack, or ISO container for stacking and/or transport. It should be appreciated that ISO locking assemblies 58 may be incorporated in slidable structure, which would enable such ISO locking assemblies 58 to be slidably adjusted to accommodate various ISO locking structure locations on the transport vehicle (i.e. truck, ship, or aircraft).

Still further, flatrack 10 includes a pair of centrally located, longitudinally extending PLS rails 60 downwardly extending from upper surface 38. The pair of PLS rails 60 are spaced apart a sufficient distance to enable flatrack 10 to be secured to complimentary PLS retaining structure incorporated on a truck-and-trailer, Army transport vehicle, or British Drop System. By way of non-limiting example, the complimentary PLS retaining structure is typically 24 inches apart. However, PLS rails 60 do not extend past the lowermost edge of interconnecting members 50 to prevent interference between PLS rails 60 and cargo roller system 32.

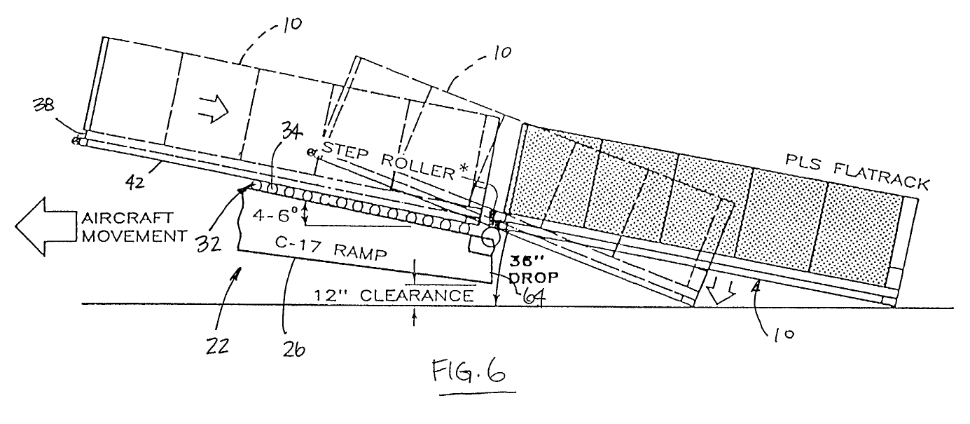

Flatrack 10 may vary widely in dimensions, but in one preferred form flatrack 10 is approximately 88 inches in width and approximately 230 inches in length. Such dimensions enable flatrack 10 to be loaded and secured within the C-17 dual 88 inch rail system. Preferably, as seen in FIGS. 2 and 5, flatrack 10 is positioned in the cargo aircraft, such as a C-17 as illustrated in the figures, in two longitudinal rows. According to this configuration, eight flatracks 10 may be positioned within a C-17, subject to various takeoff weight limitations. Six flatracks 10 would be transport on main deck 20 and an additional two flatracks 10 would be transport on lower cargo door 26.

To facilitate the off-loading of flatrack 10 from aircraft 12 at remote airfields, aircraft 12 preferably includes a step roller system 62. Step roller system 62 is disposed at a trailing edge 64 of lower cargo door 26 and is adapted to permit the free rolling of flatrack 10 out the back of cargo compartment 18 to achieve a “combat offload.” This is particularly useful when unloading equipment/cargo at airfields that are not serviced by a crane or K-loader.

Specifically, step roller system 62 includes a teeter roller 66 rotatably supported by a support assembly 68. Support assembly 68 of step roller system 62 is actuated between a raised and a lowered position using an existing actuation system 70. Existing actuation system 70 is currently used to raise and lower loading ramp extensions (toes) often used on cargo aircraft. However, such loading toes would be replaced with step roller system 62. To facilitate such replacement, connection of step roller system 62 to existing actuation system 70 is similar to the existing connecting between such actuation system 70 and the existing loading toes. This enables the retraction of step roller system 62 using aircraft power when the aircraft cargo doors are being closed.

Step roller system 62 is sized to support the weight of flatrack 10 during an offloading operation. As best seen in FIG. 6, during an offloading operation, flatrack 10 is rolled down the plurality of rollers 34 on lower cargo door 26. This is preferably accomplished while aircraft 12 is taxiing down a taxiway or rolling out from a recent landing. As flatrack 10 approaches step roller system 62, flatrack 10 rolls onto teeter roller 66. As the center of gravity of flatrack 10 passes teeter roller 66, flatrack 10 begins to “teeter” downward to contact the ground surface. During this time, the rear end of flatrack 10 is caused to raise off the plurality of rollers 34 and the forward end of flatrack 10 begins to fall toward the ground surface. As should be appreciated, the weight of flatrack 10 is transferred to teeter roller 66 and support assembly 68. Accordingly, step roller system 62 is designed to withstand these enormous forces. By way of example, it is anticipated that flatrack 10 will carry approximately 40,000 lbs. when fully loaded. Thus, step roller system 62 must support this weight.

Further rolling of flatrack 10 caused the forward end of flatrack 10 to drop and contact the ground surface. Flatrack 10 will continue to roll along teeter roller 66 until the rear end of flatrack 10 clears teeter roller 66. Once the rear end of flatrack 10 drops from lower cargo door 26, the combat offload of flatrack 10 is complete. Once flatrack 10 is on the ground, it may be quickly picked up by standard PLS trucks in less than a minute without the driver having to leave the cab of the PLS truck.

By way of example, it is anticipated that lower cargo door 26 will be lowered such that the upper support surface of lower cargo door 26 is approximately 36 inches above the ground surface and provides a 12 inch clearance between lower cargo door 26 and the corresponding grounding surface. If it proves that this 36 inch drop is too much for flatrack 10, it is anticipated that a pair of rails (not shown) may be pivotally coupled to trailing edge 64 of lower cargo door 26. This pair of rails would ride along the ground and provide an inclined support platform to enable the gradual deployment of flatrack 10 on the ground surface.

According to the principles of the present invention, flatrack 10 provides a single transportation platform capable of interfacing with standardized ISO containers, PLS truck-and-trailer systems, and cargo aircraft's 463L rail and pallet locking system. That is, flatrack 10 provides a pallet interface system that eliminates the need for a married pallet system to be used in the process of loading and supporting a CROP, flatrack, or ISO container being transported on a cargo aircraft. Furthermore, flatrack 10 provides a single pallet interface system that can be positioned on the roller assembly of a loading ramp of a cargo aircraft, such as a C-17, that also is connectable with existing ISO fitting systems, PLS systems, and aircraft pallets systems such that the entire assembly can be loaded onto or unloaded from the aircraft without the need for a large crane, and which permits combat offloads to be performed. Still further, flatrack 10 provides a pallet interface system that overcomes the disadvantages of the prior art.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A flatrack for supporting and transporting cargo on a cargo aircraft, within an ISO container, and on a PLS truck system, said cargo aircraft having a plurality of rollers and at least a pair of retaining rails, said ISO container having an ISO locking system, said PLS truck system having a PLS retaining system, said flatrack comprising:
a main body portion;
a pair of longitudinally extending planar surfaces extending along an underside of said main body portion, said pair of longitudinally extending planar surfaces being sufficiently spaced apart so as to be engageable with the plurality of rollers of the cargo aircraft, said pair of longitudinally extending planar surfaces further having a retaining flange engageable with the pair of retaining rails of the cargo aircraft;
a plurality of ISO connectors coupled to said main body portion, said plurality of ISO connectors being engageable with the ISO locking system of the ISO container; and
a PLS rail mounting system extending along said underside of said main body portion, said PLS rail mounting system being sufficiently spaced apart so as to be engageable with the PLS retaining system of the PLS truck system.

2. The flatrack according to claim 1 wherein said pair of longitudinally extending planar surfaces each comprises:
an inboard member extending downwardly from said main body portion;
an outboard member extending downwardly from said main body portion; and
an interconnecting member fixedly coupled to said inboard member and said outboard member to form said longitudinally extending planar surface, said interconnecting member extending past said outboard member to form said retaining flange, said interconnecting member being engageable with the plurality of rollers of the cargo aircraft.

3. The flatrack according to claim 2 wherein said PLS rail mounting system comprises:
a pair of spaced apart rail members longitudinally extending along said main body portion, each of said pair of spaced apart rail members having an inwardly turned hook portion connectable with the PLS retaining system of the PLS truck system.

4. The flatrack according to claim 3 wherein said pair of longitudinally extending planar surfaces define a support plane generally extending between said interconnecting members, a distance between said main body portion and said pair of spaced apart rail members of said PLS rail mounting system being less than a distance between said main body portion and said support plane.

5. A flatrack for supporting and transporting cargo on a cargo aircraft, within an ISO container, and on a PLS truck system, said cargo aircraft having a plurality of rollers and at least a pair of retaining rails, said ISO container having an ISO locking system, said PLS truck system having a PLS retaining system, said flatrack comprising:
a main body portion;
a pair of longitudinally extending planar surfaces extending along an underside of said main body portion, said pair of longitudinally extending planar surfaces being sufficiently spaced apart so as to be engageable with the plurality of rollers of the cargo aircraft, said pair of longitudinally extending planar surfaces further having a retaining flange engageable with the pair of retaining rails of the cargo aircraft;
a plurality of ISO connectors coupled to said main body portion, said plurality of ISO connectors being engageable with the ISO locking system of the ISO container; and
a PLS rail mounting system extending along said underside of said main body portion, said PLS rail mounting system having a pair of spaced apart rail members longitudinally extending along said main body portion, each of said pair of spaced apart rail members having an inwardly turned hook portion connectable with the PLS retaining system of the PLS truck system.

6. The flatrack according to claim 1 wherein said pair of longitudinally extending planar surfaces each comprises:
an inboard member extending downwardly from said main body portion;
an outboard member extending downwardly from said main body portion; and
an interconnecting member fixedly coupled to said inboard member and said outboard member to form said longitudinally extending planar surface, said interconnecting member extending past said outboard member to form said retaining flange, said interconnecting member being engageable with the plurality of rollers of the cargo aircraft.

7. The flatrack according to claim 3 wherein said pair of longitudinally extending planar surfaces define a support plane generally extending between said interconnecting members, a distance between said main body portion and said pair of spaced apart rail members of said PLS rail mounting system being less than a distance between said main body portion and said support plane.

8. An aircraft pallet system compatible with an ISO locking system and a PLS retaining system, said aircraft pallet system comprising:
an aircraft having a cargo compartment and a cargo ramp;
a plurality of rollers disposed in said cargo compartment and said cargo ramp;
a plurality of retaining rails disposed in said cargo compartment;
a flatrack having a main body portion, a pair of longitudinally extending planar surfaces extending along an underside of said main body portion, said pair of longitudinally extending planar surfaces selectively engaging said plurality of rollers, said pair of longitudinally extending planar surfaces further having a retaining flange slidably engaging said plurality of retaining rails, said flatrack further having a plurality of ISO connectors coupled to said main body portion, said plurality of ISO connectors being engageable with the ISO locking system, said flatrack still further having a PLS rail mounting system extending along said underside of said main body portion, said PLS rail mounting system having a pair of spaced apart rail members longitudinally extending along said main body portion, each of said pair of spaced apart rail members having an inwardly turned hook portion connectable with the PLS retaining system; and
at least one teeter roller assembly operably coupled to said cargo ramp for enabling deployment of said flatrack while said aircraft is moving, said at least one teeter roller assembly being removably coupled to said cargo ramp and sized to support the weight of said flatrack during said deployment.

9. The aircraft pallet system according to claim 8, further comprising:
an cargo ramp extension actuation system coupled to said cargo door, said cargo ramp extension actuation system being coupled to said at least one teeter roller assembly for positioning said at least one teeter roller between an extended position and a retracted position.

10. The aircraft pallet system according to claim 9 wherein said at least one teeter roller assembly comprises:
a support bracket coupled to said cargo ramp extension actuation system; and
a teeter roller pivotally coupled to said support bracket, said teeter roller being positioned along a trailing edge of said cargo door to enable rolling movement of said flatrack off said cargo door.
